(19) United States
(12) Patent Application Publication
(10) Pub. No.: US 2011/0004922 A1
(43) Pub. Date: Jan. 6, 2011

(54) User Specified Privacy Settings

(75) Inventors: Joseph Andrew Bono, Kirkland, WA (US); Omar H. Shahine, Menelo Park, CA (US); Paul A. Elliott, Woodinville, WA (US); Ann M. Hudspeth, Redmond, WA (US); Tyler J. Schnoebelen, San Francisco, CA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/496,555

(22) Filed: Jul. 1, 2009

(51) Int. Cl. G06F 21/00; G06Q 99/00

(52) U.S. Cl. 726/4; 705/319

(57) ABSTRACT

Customized content sharing techniques are described. In an implementation, an input is accepted that describes a particular type of content. The input is provided via selection of one or more privacy settings for a user of a social network service. The input is also used to control which other users of the social network service are permitted to communicate content to the user.

### BACKGROUND

Social network services permit users (e.g., an owner) to share content with other users (e.g. a consumer), such as the owner's friends and family. Although owners may share content with other users, at times the content may be over-shared or under-shared. Over-sharing refers to sharing content with additional users beyond those intended by the owner. For example, the owner may inadvertently share personal photographs with each user on the Internet. In contrast, under-sharing may result when the content is shared with a smaller group of users than was intended by the owner. For example, an owner may inadvertently omit a family member from receiving content because the owner forgot that the family member is not included in the owner's contact list.

### SUMMARY

User specified privacy techniques are described. In an implementation, an input is accepted that describes a particular type of content. The input is provided via selection of one or more permission controls for a user of a social network service. The input is also used to control which other users of the social network service are permitted to communicate content to the user.

In an implementation, one or more computer-readable media comprise instructions that are executable to provide a recommendation that indicates a privacy setting that is available for selection in response to an activity by a user with the social network service. The instructions are further configured to accept an input that selects which other users of the social network service are permitted to access a type of content that corresponds to the privacy setting.

In an implementation, one or more computer-readable media comprise instructions that are executable to accept selection of a privacy setting that is configured to set access to a type of content for a user of a social network service. Content for the user that corresponds to the type of content is combined with an access control object that corresponds to the privacy setting and defines which other users of the social network service are permitted to access the content. A presentation is generated, for the user, that includes the content with the access control object applied that shows how the other users are presented the content.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation that is operable to perform user specified privacy activities for a social network service.

FIG. 2 is an illustration of a system in an example implementation showing operation of a privacy module of FIG. 1 in greater detail.

FIG. 3 is an illustration of a system in an example implementation showing implementation of the privacy module of FIG. 1 to select privacy settings for content access.

FIG. 4 is an illustration of a system in an example implementation showing implementation of the privacy module of FIG. 1 to select privacy settings to control which user may communicate with the owner.

FIG. 5 is an illustration of a presentation in accordance with an aspect of the present disclosure.

FIG. 6 is an illustration of a presentation in accordance with an aspect of the present disclosure including presentation of a recommendation.

FIG. 7 is a flow diagram depicting a procedure in an example implementation that is used to accept privacy settings selection.

### DETAILED DESCRIPTION

Overview

Social network services permit users (e.g., owners) to share content with other users, e.g., consumers. For example, an owner may permit friends and family to view photographs, exchange instant messages, post comments, and so forth. Even though owners typically join a social network service to share content, the owners may have different preferences for which users may access the owner's content and with whom the owner is willing to communicate. For example, an owner who is a parent may want to share baby pictures with friends and family. In another example, an owner who is attending college may want friends to have access to the owner's photographs while preventing family members from viewing the owner's photographs.

User specified privacy techniques are described to control which users of a social network service are permitted to interact with content associated with an owner. For example, an owner may select privacy settings that permit other users to access the owner's content or are permitted to communicate content to the owner. In the foregoing manner, the owner may determine which users may access content based on content type. In addition, the users may be controlled on a hierarchical and/or concentric manner. For example, permitting users of the social network service's public-at-large to access blog entries may result in granting family members access to blog entries. In the previous example, the hierarchical and/or concentric manner may be individually set by the owner. In one or more embodiments, a privacy center provides a single place for a user (e.g., an owner) to view and/or select privacy setting.

In addition, the social network service may be configured to contextually prompt a user to increase or decrease privacy settings (e.g., adjust sharing levels) based on actions by the owner and/or other users. For example, the owner who is inviting friends to view the owner's content may be prompted to share the owner's name, picture, biographical information, and so on by adjusting one or more privacy settings.

In the following discussion, an example environment and systems are first described that are operable to perform user specified privacy techniques via a network service, e.g., a social network service. Example procedures are then described that may be implemented using the example environment as well as other environments. Accordingly, implementation of the procedures is not limited to the environment and the environment is not limited to implementation of the procedures.

Example Environment

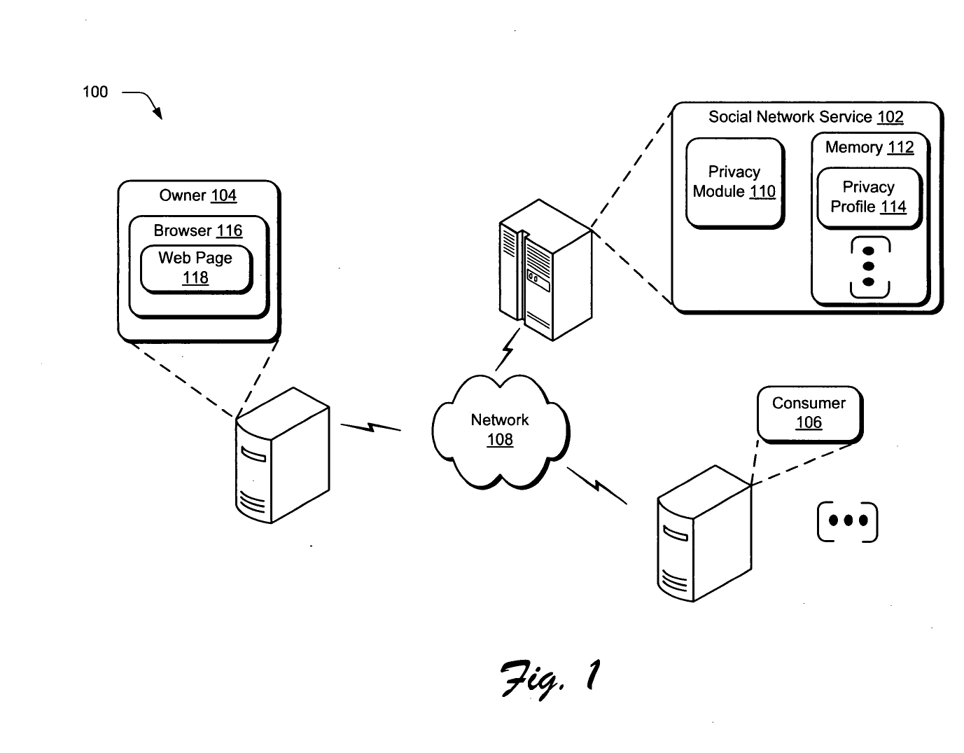

FIG. 1 is an illustration of an environment 100 in an example implementation that is operable to employ techniques for use in the selection of privacy settings. In some instances, a user may individually select privacy settings based on content type. Example content types may include photographs, video, audio clips, music files, text, blog entries, instant messages, invitations, comments, combinations of the foregoing, and so on.

The illustrated environment 100 includes a social network service 102 and a plurality of users (an owner 104 and a consumer 106 are illustrated), that are communicatively coupled via a network 108. At times in this discussion, the consumer 106 (and additional consumers) may be referred to as “other users.” Although the consumer 106 is referenced, the consumer 106 may be a potential consumer who is permitted to access the owner's content and/or communicate with the owner 104 but as of yet has not consumed content or chosen to communicate with the owner 104. For additional clarity, a user, the owner 104, or the consumer 106 may also relate to a user or person who operates a logical client of the social network service 102, such as software, a device, and so forth. The owner 104, the consumer 106, the social network service 102, and the network 108, may also be representative of more than one entity. For example, the consumer 106 may be representative of multiple consumers.

As illustrated, the social network service 102 includes a privacy module 110 and memory 112. The social network service 102 is representative of functionality to allow users (e.g., the owner 104, the consumer 106) to interact with content posted to the social network service 102. Example interactions include accessing content, communicating content (e.g., directly or by permitting access), and so on. For example, the consumer 106 may access photographs, associated with the owner 104, stored with the social network service 102. In another example, the social network service 102 may act as an intermediary (e.g., a go-between) for communications between users, e.g. so that the owner 104 may send offline messages (e.g., private messages, social network messages) to one or more other users. In embodiments, the social network service 102 may maintain a web site so the users may access content, communicate content (e.g., messages), and/or perform other activities. For example, the owner 104 may access a web page maintained by the social network service 102 to select privacy settings that are included in a privacy profile 114 for the owner 104. The privacy profile 114 may be used individualize privacy settings that are stored and operable for use by the privacy module 110 to control which users may interact with the owner's content, communicate with the owner, and so on. For example, the privacy module 110 may control access to content in a hierarchical manner. Although the social network service 102 is discussed, other network services may implement the described techniques, approaches, and so on.

In one or more embodiments, the privacy module 110 may provide a recommendation that contextually prompts the owner to increase or decrease sharing based on an action by the owner or another user. For instance, the recommendation may prompt the owner to input a selection to change a particular privacy setting so the social network service may share the owner's picture when the owner sends an invitation to another user.

For convenience, the functions performed by social network service 102 are described with respect to modules. As is to be appreciated, the modules in the social network service 102 may be arranged in a variety of ways and the described functions may be performed by a single module, performed by sub-modules, performed by a combination of modules, and so forth. For example, the modules may be executed by one or more processors of one or more server computers of the social network service 102.

The social network service 102 may be configured to perform a variety of functions and may include other modules for performing this variety. For example, the social network service 102 may include an advertising module to provide a targeted advertisement.

The privacy module 110 is representative of functionality to control which users of the social network service 102 are permitted to interact with content associated with the owner, e.g., to access content. In some implementations, the privacy module provides a single place for an owner to view and/or change privacy settings. The privacy module 110 may also control which user may communicate content to the owner. For example, the owner 104, using the privacy module 110, may permit the family members to view the content posted by the owner 104 and communicate content to the owner 104. The privacy module 110 may be configured to concentrically control access in hierarchical manner. For example, the privacy module 110 may be configured so individual users are included in a single group, such as the owner (e.g., me), close network, network, restricted network, friends of friends, public. In this way, the privacy module 110 may automatically grant users a higher level group permission to interact with content when a comparatively lower level group is given permission to interact with the content. In addition, a lower level group may not interact with the content, e.g., the public is not allowed to interact with the content. Other groups or subgroup may be included and the owner may customize groups and/or the hierarchical order. For example, the owner may grant friends greater access to content than family members.

In some implementations, the privacy module 110 controls access and/or communication based on a type of content being accessed or communicated in accordance with the owner's privacy settings. Example types of content include, but are not limited to, photographs, instant messages, offline messages, blog entries, comments, and invitations. Additional types of content include biographical information, contact information, and so on. Example content types may refer to the content itself, e.g., the content is a blog entry. The applicable meaning may be understood from the context of the discussion.

In further implementations, the privacy module 110 may accept owner selection of privacy settings that specify what content is made accessible to other users (included in a group or subset) based on content type. Although an owner may use the privacy module 110 to permit friends and family to view photographs, for instance, the privacy module 110 may be used restrict access to personal photographs to immediate family members.

In another example, the extent to which one group of users is permitted access and/or communication may be determined from the access that is granted to another group of users. For example, family members may be granted access when the owner's extended network is granted access to particular content type.

The memory 112 is representative of functionality to store data, such as content, for the social network service 102. As illustrated, the memory 112 stores the privacy profile 114 (e.g., for owner 104) on behalf of the privacy module 110. The privacy profile 114 may include various privacy settings input by the owner 104 regarding which user may interact with content, e.g., access the owner's content, communicate content to the owner 104, and so on. Additionally, although a single memory 112 is shown, a wide variety of types and combinations of memory (e.g., tangible memory) may be employed, such as random access memory (RAM), hard disk memory, removable medium memory, external memory, and other types of computer-readable media.

The users, such as the owner 104 and the consumer 106, are configured to provide functionality to interact with content, such as by communicating content, accessing content, performing activities, and so forth with the social network service 102. The user may interact with the social network service 102 via a web browser (e.g., web browser 116) that is operable to access the web site for the social network service 102. For example, the owner 104 may receive and render a web page 118 that is supported by the privacy module 110 to customize the owner's privacy profile. The owner may customize individual privacy settings based on the owner's preferences. Thus, the owner 104 may customize which users may interact with the owner's account, e.g., communicate content to the owner 104, access the owner's content, and so on.

The users may be implemented in a variety of ways, such as personal computers, mobile computing devices, smart phones, laptops, and so on. The users (e.g., the owner 104, the consumer 106) may be configured with limited functionality (e.g., thin devices) or with robust functionality, e.g., thick devices. Thus, a device's functionality may relate to the device's software or hardware resources, e.g., processing power, memory (e.g., data storage capability), network resources, and so on.

Moreover, in some instances the owner may be a consumer of the owner's content, e.g., by viewing the owner's content. Although the term owner is used, the owner may merely be a user who posted the content. In addition, a consumer may also own content, e.g., the consumer posted content to the social network service.

As further illustrated in FIG. 1, the owner 104, the consumer 106, and the social network service 102 may communicate via the network 108. Although the network 108 is illustrated as the Internet, the network 108 may assume a wide variety of configurations. For example, the network 108 may include a wide area network (WAN), a local area network (LAN), a wireless network, a public telephone network, an intranet, and so on. Further, although a single network is shown, the network 108 may be configured to include multiple networks.

Generally, any of the functions described herein can be implemented using software, firmware, hardware (e.g., fixed logic circuitry), manual processing, or a combination of these implementations. The terms “module,” “functionality,” and “logic” as used herein generally represent software, firmware, hardware, or a combination of software, firmware, or hardware. In the case of a software implementation, the module, functionality, or logic represents program code that performs specified tasks when executed on a processor (e.g., CPU or CPUs). The program code can be stored in one or more computer-readable memory devices (e.g., one or more tangible media), and so on. The structures, functions, approaches, and techniques described herein may be implemented on a variety of commercial computing platforms having a variety of processors.

Processors used to execute software in software implantations are not limited by the materials from which they are formed or the processing mechanisms employed therein. For example, processors may be comprised of semiconductor(s) and/or transistors (e.g., electronic integrated circuits (ICs)). Having discussed the environment 100, sample systems that are operable to implement customizable content sharing techniques are now described.

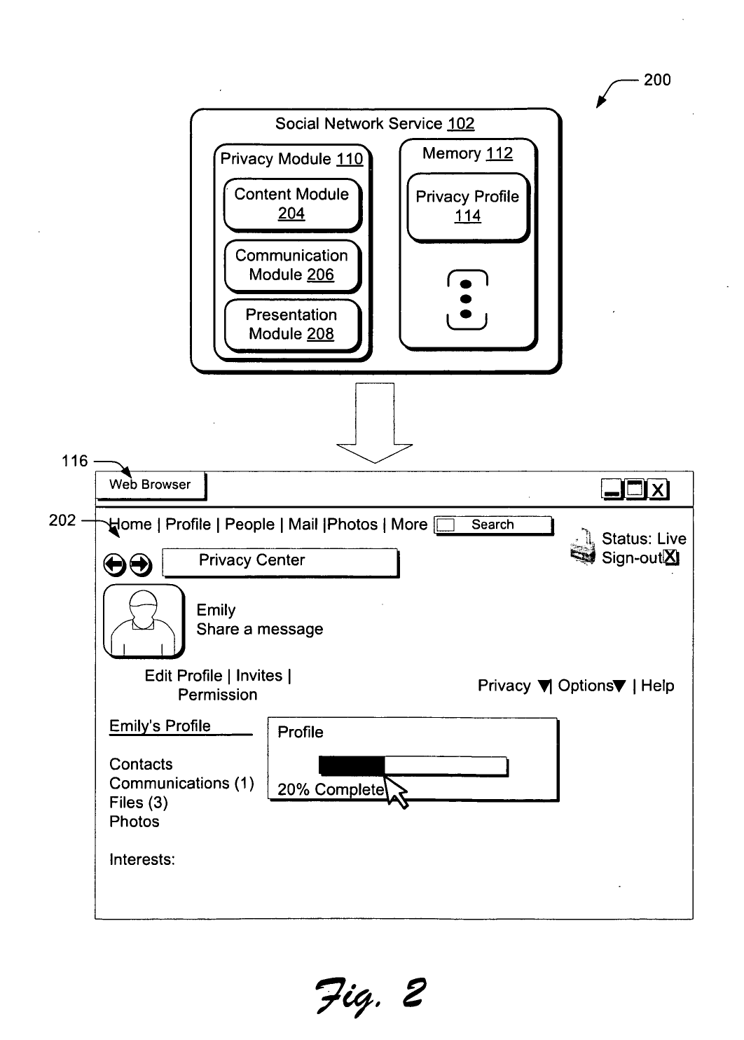

FIG. 2 depicts a system 200 in an example implementation illustrating operation of the privacy module 110 in further detail. In addition, an example, web page 202 is also illustrated that may be presented through use of the privacy module 110 and output via a web browser, e.g., via web browser 116. In the illustrated embodiment, the web page provides a single place for a user to view privacy profile information, privacy settings, change privacy setting (e.g., from a default setting), and so on.

As illustrated, the privacy module 110 includes a content module 204, a communication module 206, and a presentation module 208. In some implementations, the privacy module 110, including the content and communication modules 204, 206, implement one or more privacy settings that are used by the privacy module 110. The privacy module 110 may use permission controls that correspond to the privacy settings to manage access to content in accordance with permission access model techniques. By managing interactions in this manner, the owner 104 may individualize which users may communicate content and/or access the owner's content. For example, an owner who attends college may grant friends greater access to photographs than the owner's family members. In this case, friends who use the social network service 102 are hierarchically granted greater access than family members who use the social network service 102.

The privacy module 110 may be used to maintain one or more web pages (e.g., included in the web site supported by the social network service 102) that permit the owner 104 to input a selection, via privacy settings, of what content users are permitted to access, which users may communicate with the owner 104, and so forth. The privacy center web page 202 permits the owner 104 to interact with the functionality provided by the privacy module 110, such as to provide one or more privacy settings. For example, the owner 104, “Emily” (referred to at various times for explanatory purposes only), may interact with the privacy module 110 via the web page 202 to customize which users may interact with Emily via the social network service 102, e.g., via Emily's account. Thus, the owner 104 may control access to content previously posted and or content that the owner 104 may subsequently post without interacting with each item of content individually.

The content module 204 is representative of functionally to control interaction with content posted by the owner 104 that is stored in memory 112 and/or accessible via the social network service 102. An example of the latter case may be content that is available from a feed of content, e.g., a feed source.

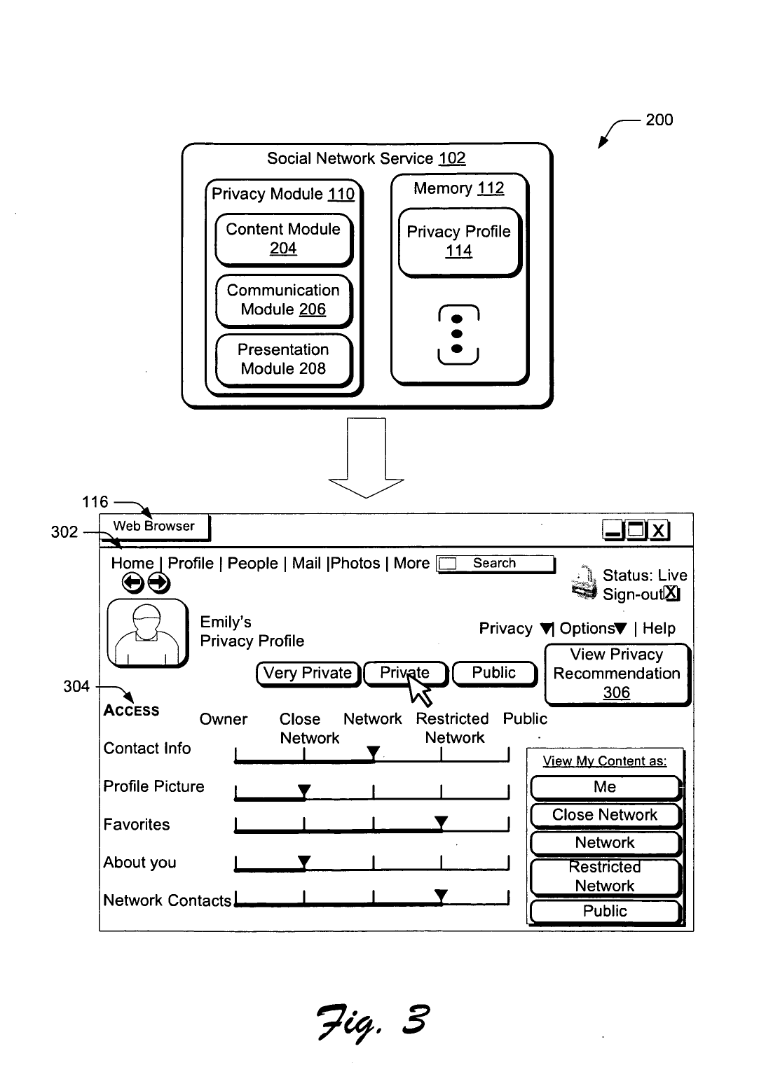

Example feed sources, include but are not limited to, YOUTUBE (YouTube, LLC, San Bruno, Calif.), PHOTOBUCKET (Photobucket, Inc., San Francisco, Calif.); communication sources (e.g., TWITTER (Twitter, Inc. San Francisco, Calif.)); and so on. The feed sources may be accessed via a link that is posted to the social network service 102. The link may operable to direct a web browser to a web page that includes the referenced content and is maintained by the feed source. Additional description of the functions provided by the content module 204 is described in conjunction with FIGS. 3 and 5-6.

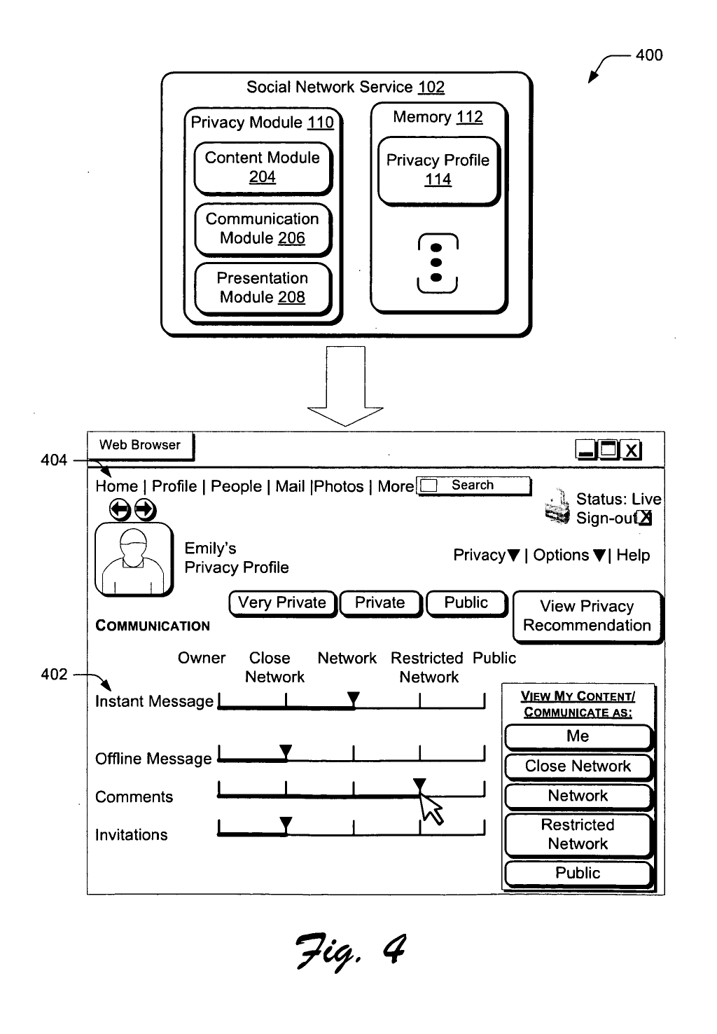

The communication module 206 is representative of functionality to control which users are to be permitted to communicate content to the owner 104 via the social network service 102. Example communications include, but are not limited to, blog entries, instant messages, offline messages, comments, and file transfers. Further discussion of the functions provided by the communication module 206 is described in conjunction with respect to FIGS. 4-6.

The presentation module 208 is representative of functionality to provide presentations on behalf of the privacy module 110 for output in a web browser. For example, the presentation module 208 may be used to display the privacy center web page 202 so a user may view and change the user's privacy profile, individual privacy settings, and so on.

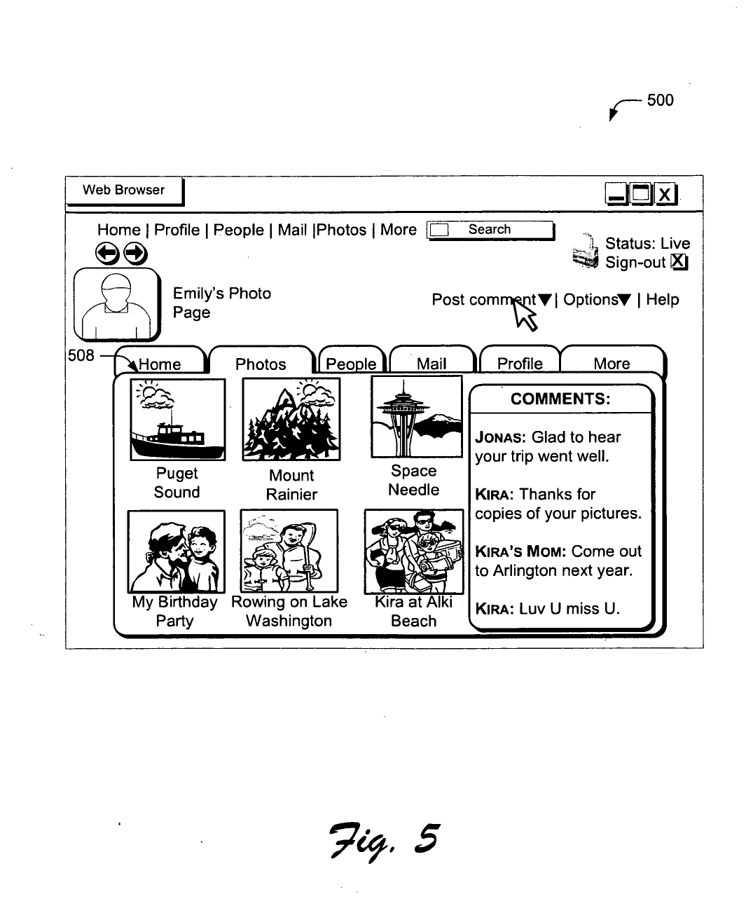

As will be described in conjunction with FIGS. 5 through 7, in some implementations the presentation module 208 may be configured to present the owner's content from the perspective of another user. For example, the owner 104 may view the owner's content from the perspective of another user to confirm the content appears as intended. For example, the owner 104 may view the owner's photographs from a family member's perspective to determine that the photographs appear or do not appear based on the owner's preferences.

As illustrated in FIG. 3, the system 200 is illustrated in which the content module 204 may be used to select privacy settings that are used to control which users are permitted access to the content associated with the owner 104. For illustration purposes only, slide-bars are illustrated to accept input. In some implementations, the privacy setting may be based on the content's type, e.g., photographs, blog entries. For example, by using the slide bars, the owner 104 may grant access to a broader group of users for some types of content than other types of content.

Users may be included in groups that include, but are not limited to, the owner (no other users are permitted access); a close network (e.g., family members); and a network (e.g., the owner's friends are permitted access). Additional examples include a restricted network, friends of friends; the public (e.g., each user of the social network service or public-at-large); and so on. Although finite levels (e.g., owner, network) are illustrated, in other instances the owner 104 may be permitted to scale which other users are permitted access to the content for the owner.

A variety of hierarchical arrangements may be implemented. Although family members may be granted greater access than friends, in some instances (for example) friends may be granted greater access than family members. Thus, granting access to the owner's network may also grant access to users in the owner's restricted network. Thus, the group restricted network may be concentric with the group network and have a higher level of sharing than the group network. The hierarchal arrangement of groups may be individualized based on the owner's preferences.

As illustrated, the content module 204 may also permit a user to customize which privacy setting are applied according to a default privacy type (e.g., very private, private, public). Therefore, the owner 104 may select the default very private and then customize individual privacy setting for greater exposure than that which corresponds to the default privacy type. In this case, the content module 204 applies access control objects that correspond to the customized privacy settings. A variety of other examples are also contemplated.

As illustrated, the privacy module 112 may also contextually prompt the user by providing recommendations. For example, the owner 104 may select the “view privacy recommendation” button 306 to view privacy recommendations that are based an activity by the owner 104 and/or an activity by one or more other users. For example, when the owner 104 “Emily” sends an invitation to “Eleanor,” another user, a recommendation may be to allow Eleanor to view Emily's profile picture to increase the likelihood that Eleanor will accept the invitation.

In another example, based on the owner's previous activities, the content module 204 may determine that the owner 104 is likely to permit another user to interact with the owner's content. When the owner 104 has previously communicated with the other user, for instance, the content module 204 may provide a recommendation to allow similar requests from the other user. In an additional example, Emily may view a recommendation that indicates Eleanor has unsuccessfully attempted to access Emily's photographs when Emily selects the “view privacy recommendation” button 306. A recommendation may also accept Emily's input to permit Eleanor to access the photographs. Thus, the recommendation may provide a notification of activities by the owner and/or other users that indicate a likelihood that content is over-shared or under-shared.

In addition, the recommendation may include functionality (in conjunction with the privacy module 110) to adjust privacy settings to increase or decrease the owner's sharing level. For example, the recommendation may notify the owner 104 that a particular user has unsuccessfully requested access to photographs and provide selections that may be used to change an applicable privacy setting to allow access. In some implementations, the privacy module 110 may be configured to implement heuristic techniques as part of the determination as to the recommendation and what selections to offer, e.g., to permit or restrict access based on past actions observed by the privacy module 110.

In additional implementations, the privacy module 110, including the content module 204, may be configured to apply heuristically determined selections. For example, the owner 104 may indicate that the privacy module 110 is to adaptively learn whether to grant or deny access based on activity by the owner and/or activity by other users. In this way, the owner 104 may originally select privacy settings and then select to permit the privacy module 110 to adaptively adjust the owner's selections. Having described the content module 204, the communication module 206 is now discussed in relation to the following figure.

Referring to FIG. 4, a system 400 is illustrated in which the communication module 206 is used to select which users may communicate content to the owner 104, e.g., a user account for the owner 104. The owner 104 may select which users may communicate content through selection of one or more privacy settings that are applied by the communication module 206. As illustrated, selection of which other users may communicate content may be tailored based on the type of content that is being communicated, e.g., an instant message.

In a similar manner to the operation of the content module 204, the owner 104 using the communication module 206 may select which types of content the owner 104 is willing to accept. In addition, the communication module 206 may be used to select from which users the content may originate. For example, Emily may select to receive instant messages from each user in her network while accepting invitations from users in her close network.

In addition to manual selection of privacy settings, the owner 104 may select a default privacy type (e.g., very private, private, public) which may set which users the communication module 206 will allow to communicate with the owner 104. For example, selection of the button “very private” 406 may grant immediate family permission to communicate content to the owner 104. In another example, the owner may select a privacy type and then individualize privacy settings.

In some embodiments, the communication module 206 may be configured to apply heuristic techniques to determine which types of content may be communicated to the owner 104. For example, the owner 104 may select to have the communication module 206 adaptively learn which users are permitted to communicate content based on activities by the owner 104. For example, when Emily deletes or does not read an instant message from Dave, the communication module 206 may block instant messages from Dave and/or block messages from users in a group to which Dave belongs. Thus, the communication module 206 may block content from each “friends of friends” due to activity by a user that is a “friend of a friend.” A variety of other examples are also contemplated.

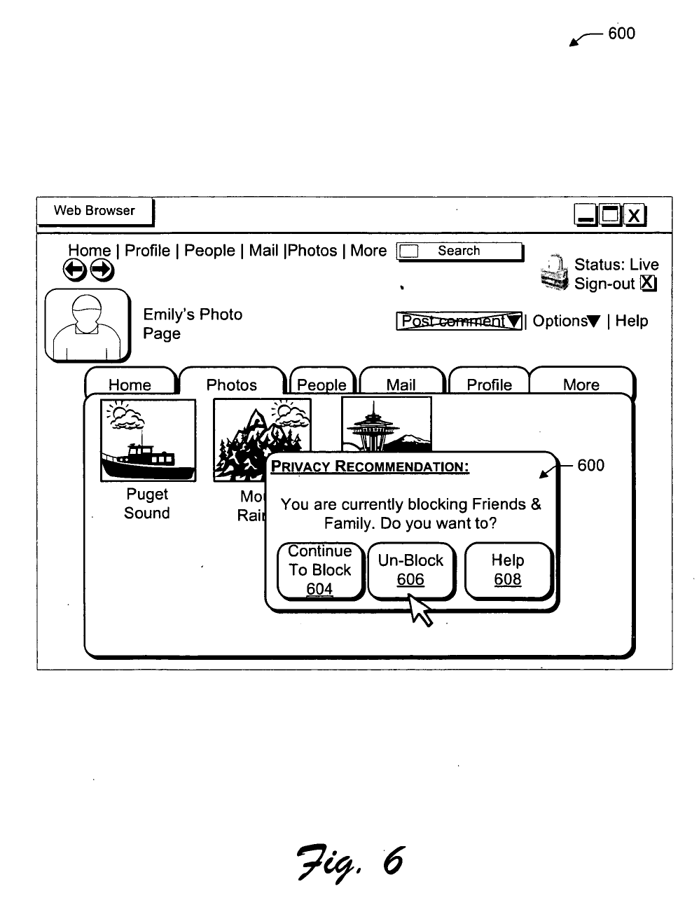

Referring to FIGS. 5 and 6, example presentations are illustrated and described in conjunction with operation of the content and communication modules. The presentation module 208 may be used to generate the presentations that are output via a web browser, e.g., web browser 116.

The presentation module 208 may be configured to generate a presentation for the owner 104 that is configured from the perspective of another user. For example, the owner 104 may select to view the owner's content as if the owner 104 is another user of the social network service 102. Thus, the owner 104 may confirm that content appears and/or does not appear in accordance with the owner's preferences.

As illustrated in FIG. 5, an example presentation 500 is output via web browser 116. In the presentation 500, the owner 104 may select to view the owner's photographs and associated comments from the perspective of a family member. The presentation 500 may also permit the owner 104 to communicate from the perspective of the family member so the owner 104 may verify that family members are permitted to post comments. The illustrated presentation 500 may be based on the owner selecting that users in the close network (e.g., family) are to be permitted to view photographs and post comments.

As illustrated in FIG. 6, an example presentation 600 is shown from the perspective of user in the public-at-large, e.g., a user of the Internet. In addition, a recommendation 602 that provides a contextual prompt is also illustrated. The owner 104 in this example has selected to permit members of the public-at-large to access some of the owner's 104 photographs (e.g., non-personal photographs). However, the owner 104 has configured the communication module 206 and the content module 204 to prohibit members of the public-at-large from, respectively, posting comments and from viewing personal photographs, e.g., “my birthday party,” “rowing on Lake Washington,” and “Kira at Alki Beach” as shown in FIG. 5.

The owner 104 may limit access to particular content (e.g., personal photographs) by using the privacy module 110 to restrict access. While the owner 104 has selected a privacy setting that permits the public-at-large to access photographic content, the owner 104 may select to restrict access to personal photographs, e.g., prohibit a user who is a member of the public-at-large from accessing personal photographs. In this way, the content module 204 may restrict access to particular content although access would be permitted based on the content's type for the particular content.

FIG. 6 additionally illustrates a recommendation 602 that notifies the owner that “friends and family” are currently prohibited from access content. The recommendation may also offer selections, such as an un-block button 604, a continue to block button 606, a help button 608, that are related to the recommendation 602. As is to be appreciated, a recommendation may be provided in a variety of other situations.

Example Procedures

The following discussion describes procedures that may be implemented utilizing the previously described systems, techniques, approaches, and modules. Aspects of each of the procedures may be implemented in hardware, firmware, software, or a combination thereof. The procedures are shown as a set of blocks that specify operations performed by one or more devices and are not necessarily limited to the orders shown for performing the operations by the respective blocks. In portions of the following discussion, reference will be made to the environment 100 of FIG. 1 and the systems described above.

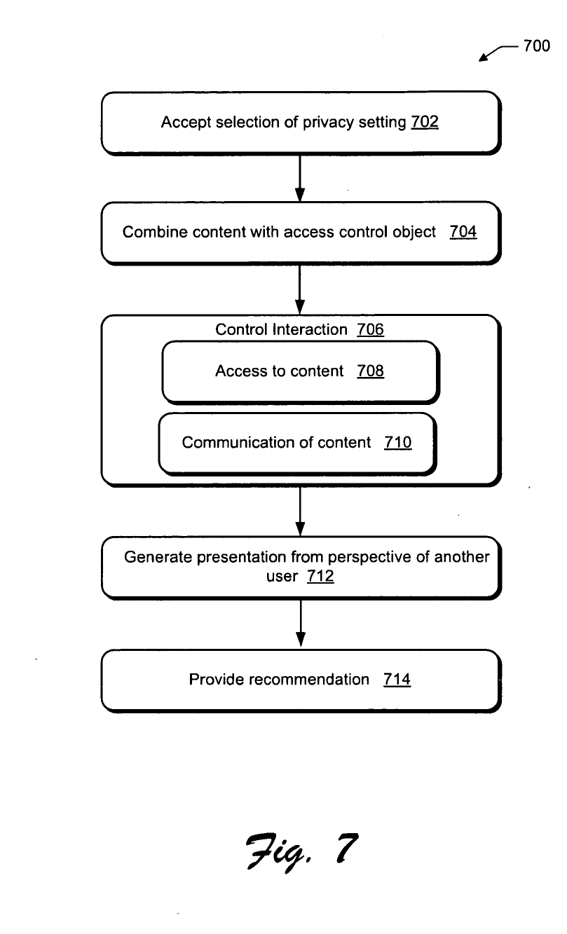

FIG. 7 depicts a procedure 700 in an example implementation in which user specified privacy techniques are implemented for a network service. For example, the procedure 700 may be used to control which users are permitted to interact with content associated with the owner. Example interactions include, but are not limited to, access to content posted by the owner, communication of content to the owner, and so on. Content posted by the owner 104 may include content that is stored in memory with the social network service 102 and/or content available via a link that is associated with the owner 104.

Selection of privacy settings is accepted (block 702). Selection of privacy settings may be performed by accepting an input entered via manual selection, selection of a privacy type (e.g., very private, public), selection that permits application of adaptively learned permission controls (e.g., permit a privacy module to heuristically determine whether interaction is permitted), and as so forth. For example, the owner 104 may manually select which other users are to be permitted to access different content, a type of content, and so on. The privacy settings may also be used to select which users are permitted to communicate with the owner 104.

In one or more embodiments, content is combined with an access control object that correspond to the privacy settings (block 704). Content posted to the social network service 102, for instance, may be combined with an access control object that includes a permission expression that specifies which of the other users of the social network service 102 are permitted to access the content. For example, a link to a web page including content may be combined with an access control object. The access control object may include a permission expression that grants access to the owner's family, when the owner 104 has selected to permit access by the owner's family.

Interaction with the content is controlled (block 706). For example access to content (block 708) associated with the owner may be controlled using an access control object. For example, an access control object may be used to perform a check to determine whether a user requesting access to particular content is permitted access. In another example, the permission controls may be used to control which users are permitted to communicate with the owner (block 710). Whether the other users are to be permitted to communicate may be based on what content is to be communicated, e.g., by content type. For example, a user may be permitted to send a private message while being prohibited from sending an instant message.

In some embodiments, a presentation from the perspective of one of the other users is generated (block 712). For example, a presentation from the perspective of the consumer 106 in the owner's restricted network may be generated for presentation to the owner 104. In this way, the owner 104 may observe how and what content is presented, what communication is permitted for the consumer 106 included in the restricted network, and so on.

In further embodiments, a recommendation is provided (block 714). For example, the recommendation may be provided in response to an activity by the owner or another user. A variety of other examples are also contemplated.

Conclusion

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A computer-implemented method comprising:
accepting an input provided via selection of one or more privacy settings for a user of a social network service, the input describing a particular type of content; and
controlling which other users of the social network service are permitted to communicate content to the user via the social network service based on the input.

2. A computer-implemented method as described in claim 1, wherein said privacy settings are provided in a single place.

3. A computer-implemented method as described in claim 1, further comprising providing a recommendation that indicates a particular said privacy setting that is available for selection in response to an activity by the user with the social network service.

4. A computer-implemented method as described in claim 3, wherein the recommendation is heuristically determined.

5. A computer-implemented method as described in claim 1, wherein a particular said privacy setting corresponds to an access control object that includes content that corresponds to the type of content.

6. A computer-implemented method as described in claim 1, wherein each said privacy setting is useable to grant access to one or more of:
an extended network for the user,
a network that includes the user,
a subset of the network that includes the user,
publicly available, or
the user.

7. A computer-implemented method as described in claim 1, wherein the controlling permits communication of one or more of the following content types:
an instant message,
an offline message,
a comment, or
an invitation.

8. A computer-implemented method as described in claim 1, wherein each of the other users is included in a single group.

9. One or more computer-readable media comprising instructions that are executable to output a user interface to:
provide a recommendation that indicates a privacy setting that is available for selection in response to an activity by a user with a social network service;
accept an input that selects which other users of the social network service are permitted to access a type of content that corresponds to the privacy setting.

10. One or more computer-readable media as described in claim 9, wherein the instructions are further executable to cause the user interface to output a recommendation based on an activity by one or more of the other users with the social network service.

11. One or more computer-readable media as described in claim 9, wherein the user interface is configured to output each privacy setting that is available for selection by the user.

12. One or more computer-readable media as described in claim 9, wherein the recommendation is configured to indicate an unsuccessful attempt to access content that is likely to be permitted access based on an activity by the user with the social network service.

13. One or more computer-readable media as described in claim 9, wherein the instructions are further executable to cause the user interface to accept selection of content that is to be restricted to a subset of the other users that are permitted access according to the content's type.

14. One or more computer-readable media as described in claim 9, wherein the type of content comprises one or more of:
contact information,
photographic content,
biographical information,
contact information,
blog content,
instant message content, or
comment information.

15. One or more computer-readable media comprising instructions that are executable to:
accept selection of a privacy setting to set access to a type of content for a user of a social network service;
combine content, for the user that corresponds to the type of content, with an access control object that corresponds to the privacy setting and defines which other users of the social network service are permitted to access the content; and
generate a presentation for the user that includes the content with the access control object applied that shows how the other users are presented with the content.

16. One or more computer-readable media as described in claim 15, wherein the other users are included in one or more of:
an extended network for the user,
a network that includes the user,
a subset of the network that includes the user, or
public-at-large.

17. One or more computer-readable media as described in claim 15, wherein the content comprises one or more of:
contact information,
a photograph,
biographical information,
a contact list,
a blog entry,
instant messaging, or
comments.

18. One or more computer-readable media as described in claim 15, wherein the instructions are further executable to:
output a recommendation that relates to the permission control based on one or more of an activity with the social network service by the user or an activity by one or more of the other users with the social network service.

19. One or more computer-readable media as described in claim 18, wherein the recommendation is heuristically determined.

20. One or more computer-readable media as described in claim 15, wherein the instructions are further executable to restrict access to a subset of the other users that are permitted access to the content based on the content's type in response to receipt of selection to restrict access to the content.
